(19) United States
(12) Patent Application Publication
(10) Pub. No.: US 2022/0146761 A1
(43) Pub. Date: May 12, 2022

(54) MAGNETIC SEATING FOR FIBER OPTIC COMPONENT

(71) Applicant: 3M INNOVATIVE PROPERTIES COMPANY, St. Paul, MN (US)

(72) Inventors: Michael A. Haase, St. Paul, MN (US); Nicholas A. Lee, Woodbury, MN (US); Terry L. Smith, Roseville, MN (US)

(21) Appl. No.: 17/440,465

(22) PCT Filed: Mar. 31, 2020
(86) PCT No.: PCT/IB2020/053063

§ 371 Date: Sep. 17, 2021

Related U.S. Application Data
(60) Provisional application No. 62/828,547, filed on Apr. 3, 2019.

(51) Int. Cl. G02B 6/38; G02B 6/42

(52) U.S. Cl. CPC G02B 6/3886; G02B 6/4236; G02B 6/4292

(57) ABSTRACT

An optical assembly includes an optical ferrule including a light redirecting member configured to receive light from an optical waveguide along a first direction and redirect the light along a different second direction, the redirected light exiting the optical ferrule at an exit location on a mating surface of the optical ferrule, and a cradle with a mating surface and configured to hold and align the optical ferrule to an optical component, wherein the mating surface of the optical ferrule and the mating surface of the cradle are held together by a magnetic attraction between opposing magnetic elements, wherein the optical ferrule and the cradle, but not the opposing elements, physically contact each other.

### SUMMARY

In some aspects of the present description, an optical assembly is provided, including an optical ferrule including a light redirecting member configured to receive light from an optical waveguide along a first direction and redirect the light along a different second direction, the redirected light exiting the optical ferrule at an exit location on a mating surface of the optical ferrule, and a cradle including a mating surface and configured to hold and align the optical ferrule to an optical component, wherein the mating surface of the optical ferrule and the mating surface of the cradle are held together by a magnetic attraction between opposing magnetic elements, wherein the optical ferrule and the cradle, but not the opposing elements, physically contact each other.

In some aspects of the present description, a method is provided, including the steps of attaching a cradle to an optical component, and coupling an optical ferrule including a light redirecting member to the optical component via the cradle, such that a mating surface of the optical ferrule is held adjacent to and facing a mating surface of the cradle by a magnetic attraction from spaced-apart magnetic components.

In some aspects of the present description, an optical assembly is provided, including an optical ferrule comprising a first mating surface and a first magnetic feature, and a receiving component including a second mating surface and a second magnetic feature, wherein the first mating surface of the optical ferrule is reversibly assembled to the second mating surface of the receiving component by a magnetic attraction between the first magnetic feature and the second magnetic feature, and the first magnetic feature and second magnetic feature are not in physical contact.

In some aspects of the present description, an optical ferrule is provided, the optical ferrule configured to be assembled to a receiving component by a magnetic attraction. The optical ferrule includes an optical waveguide support configured to receive an optical waveguide, a light redirecting member configured to receive light from an optical waveguide received in the optical waveguide support along a first direction and redirect the received light along a different second direction, and a magnetic feature configured to engage the optical ferrule to the receiving component by a magnetic attraction.

In some aspects of the present description, a cradle configured to be assembled to an optical ferrule is provided. The cradle includes a magnetic feature configured to engage the cradle to the optical ferrule by a magnetic attraction to form an optical assembly. The resulting optical assembly is configured to mount on a substrate, such that when the optical assembly is mounted on the substrate, the optical ferrule optically couples to an optical component of the substrate.

### BRIEF DESCRIPTION OF THE DRAWINGS

FIG. 1 is an exploded, perspective view of an optical assembly in accordance with an embodiment described herein;

FIG. 2 is an exploded, perspective view of an optical assembly in accordance with an embodiment described herein;

FIGS. 3A and 3B are exploded, perspective views of an optical assembly in accordance with an alternate embodiment described herein;

FIG. 4A is a perspective view of an assembled optical assembly in accordance with an embodiment described herein;

FIG. 4B is a cross-sectional side view of an assembled optical assembly in accordance with an embodiment described herein;

FIG. 5 is an exploded, perspective view of an alternate embodiment of an optical assembly in accordance with an embodiment described herein;

FIG. 6 is a flowchart detailing a method for coupling an optical ferrule to an optical component in accordance with an embodiment described herein;

FIG. 7 is a perspective view of a magnetic cover used for assembling a cradle to an optical component in accordance with an embodiment described herein;

FIG. 8 is a flowchart detailing an alternate method for coupling an optical ferrule to an optical component in accordance with an embodiment described herein;

FIG. 9 is a flowchart detailing a method for using an optical ferrule to align a cradle to an optical component in accordance with an embodiment described herein;

FIGS. 10A-10D are perspective views of an optical assembly featuring a ferrule-to-ferrule coupling in accordance with an embodiment described herein;

FIGS. 11A-11B illustrate a method of maintaining a gap between magnetic components to provide a residual magnetic force between mating surfaces in an optical assembly in accordance with an embodiment described herein; and

FIGS. 12A-12E provide cross-sectional, exploded views of an optical assembly in accordance with an embodiment described herein.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

According to some aspects of the present description, an optical assembly is provided, including an optical ferrule with a light redirecting member configured to receive light from an optical waveguide (such as an optical fiber) along a first direction and redirect the light along a different second direction, the redirected light exiting the optical ferrule at an exit location on a mating surface of the optical ferrule, and a cradle including a mating surface and configured to hold and align the optical ferrule to an optical component (such as a light source or a light detector), wherein the mating surface of the optical ferrule and the mating surface of the cradle are held together by a magnetic attraction between opposing magnetic elements, wherein the optical ferrule and the cradle, but not the opposing elements, physically contact each other. The magnetic attraction may be caused by the interaction of opposing elements, such as magnetic components or magnetic features in the optical ferrule and the cradle. These magnetic elements may include, but are not limited to, permanent magnets, electromagnets, and/or ferromagnetic materials. It should be noted that the phrase “magnetic component”, as used throughout this specification, may refer to the material of a component itself. For example, when the cradle is made of a ferromagnetic material, the cradle itself (or the material from which it is made) may be considered to be a “magnetic component” as defined herein. Also, the terms “magnetic component” and “magnetic feature” shall be considered to be synonymous with each other and may be used interchangeably.

In some embodiments, the magnetic attraction may be between the cradle and a cap, such that the optical ferrule is sandwiched between the cap and the cradle and held in place by a magnetic attraction between the cap and the cradle. In some embodiments, the magnetic attraction provides for a reversible assembly of two components (e.g., optical ferrule and cradle, or cap and cradle) by holding a mating surface of the optical ferrule in alignment with an optical component, such as a light source or a light detector. In some embodiments, the magnetic attraction is such that a magnetic force holds the optical ferrule seated in the cradle, the force applied in a direction substantially orthogonal to the direction by which light is received by the optical ferrule through the optical waveguide.

In some embodiments, the opposing magnetic elements (i.e., magnetic components) are positioned such that the mating surface of the optical ferrule is held in physical contact with a mating surface of the cradle, but the opposing elements are not in physical contact. That is, when the optical ferrule and cradle are properly mated, the magnetic components are held in proximity to each other but not allowed to physically touch, thereby creating a constant magnetic force between the components which holds the optical ferrule and cradle against each other in a mated position. In some embodiments, this purposeful gap between magnetic components creates the attractive force necessary to hold the system components in a proper mated position without requiring precise placement of the magnetic components during assembly (i.e., a gap between magnetic components maintains a magnetic force but does not require precision alignment of the magnetic components.) It should be noted that, in some embodiments, precise alignment between the optical ferrule and the cradle may be provided by mechanical features built into the optical ferrule and/or the cradle, but it is the magnetic attractive force that holds the components in a mated position, not the mechanical features. In this way, the tolerances inherent in the magnetic components and their geometry will not affect the alignment negatively.

According to some aspects of the present description, a method is provided, including the steps of attaching a cradle to an optical component (e.g., a substrate including a light sensor or light detector), and coupling an optical ferrule including a light redirecting member to the optical component via the cradle, such that a mating surface of the optical ferrule is held adjacent to and facing a mating surface of the cradle by a magnetic attraction. The magnetic attraction may be provided by magnetic components (e.g., magnets, ferromagnetic inserts, etc.) integrated into the optical ferrule and the cradle, or, alternately, into the cradle and an optional cap, such that the magnetic attraction between the cap and the cradle will hold the optical ferrule in place. In some embodiments, the magnetic components will be positioned such that a small gap exists between the magnetic components when the optical ferrule is correctly mated with the cradle. The gap may be designed to provide a continual magnetic force to hold the optical components of the system in a mated position.

In some embodiments, a temporary cover is placed over the cradle prior to its attachment to the optical component. This cover, in some embodiments, may prevent contaminants from entering the cradle during the attachment process, and it may be removed after the cradle is attached and prior to the coupling with the optical ferrule. The cover may also be left on the cradle after the attachment process, during handling and transport of the optical component and cradle combination, until such time as the ferrule is placed in the cradle, thereby preventing dust or debris from entering the cradle. In some embodiments, the cover may be held in place by a magnetic attraction to the cradle.

In other embodiments, an optical ferrule may be inserted into the cradle prior to the step of attaching the cradle to the optical component. In these embodiments, light from the optical ferrule may be used in an active alignment process when attaching the cradle to the optical component. In some embodiments, the optical ferrule used in the attachment process may be the actual optical ferrule intended for coupling with the optical component. In other embodiments, the optical ferrule may be a specific, separate optical ferrule attached to a manufacturing fixture and reused in other cradle attachment steps.

According to some aspects of the present description, an optical assembly is provided, including an optical ferrule comprising a first mating surface and a first magnetic feature, and a receiving component including a second mating surface and a second magnetic feature, wherein the first mating surface of the optical ferrule is reversibly assembled to the second mating surface of the receiving component by a magnetic attraction between the first magnetic feature and the second magnetic feature, and the first magnetic feature and second magnetic feature are not in physical contact. In some embodiments, the receiving component may be a cradle bonded to an optical component, such that the cradle holds the optical ferrule in alignment with the optical component. In some embodiments, the receiving component may be a second optical ferrule. In some embodiments, the magnetic attraction is between components, such as between the optical ferrule and the receiving component, or between a cap and the receiving component, where the optical ferrule is held between the cap and receiving component by a magnetic attraction between the cap and the receiving component. In some embodiments, a gap is maintained between the first mating feature and the second mating feature, such that the attractive magnetic force continues to act to hold the optical ferrule properly mated to the cradle.

In some embodiments, the optical ferrule includes a light redirecting member configured to receive light from an optical waveguide (e.g., an optical fiber connected to an input of the optical ferrule) along a first direction (i.e., a direction substantially parallel to the optical waveguide), and redirect the light along a different second direction. In some embodiments, the magnetic force acts in a direction different from the first direction, holding the optical ferrule in place and in alignment with the receiving component. In some embodiments, the direction of the redirected light is substantially equal to the direction of magnetic force. In other embodiments, the direction of the redirected light is different from the direction of the magnetic force.

In some embodiments, the light redirecting member may rely on total internal reflection to redirect the light entering or exiting the optical waveguides attached to the light redirecting member. Total internal reflection occurs when a propagating light wave strikes a surface at an angle which exceeds a “critical angle” with respect to the normal to the surface it is striking. The critical angle is defined as the angle of incidence above which total internal reflection occurs.

According to some aspects of the present description, an optical ferrule is provided. The optical ferrule may be configured to be assembled to a receiving component, such as a cradle or a second optical ferrule, by a magnetic attraction. The optical ferrule includes an optical waveguide support configured to receive an optical waveguide, a light redirecting member configured to receive light from an optical waveguide received in the optical waveguide support along a first direction and redirect the received light along a different second direction, and a magnetic feature configured to engage the optical ferrule to the receiving component by a magnetic attraction.

According to some aspects of the present description, a cradle configured to be assembled to an optical ferrule is provided. In some embodiments, the cradle may include a magnetic feature configured to engage the cradle to the optical ferrule by a magnetic attraction to form an optical assembly. The resulting optical assembly may be configured to mount on a substrate, such that when the optical assembly is mounted on the substrate, the optical ferrule optically couples to an optical component of the substrate (e.g., a light source or a light detector).

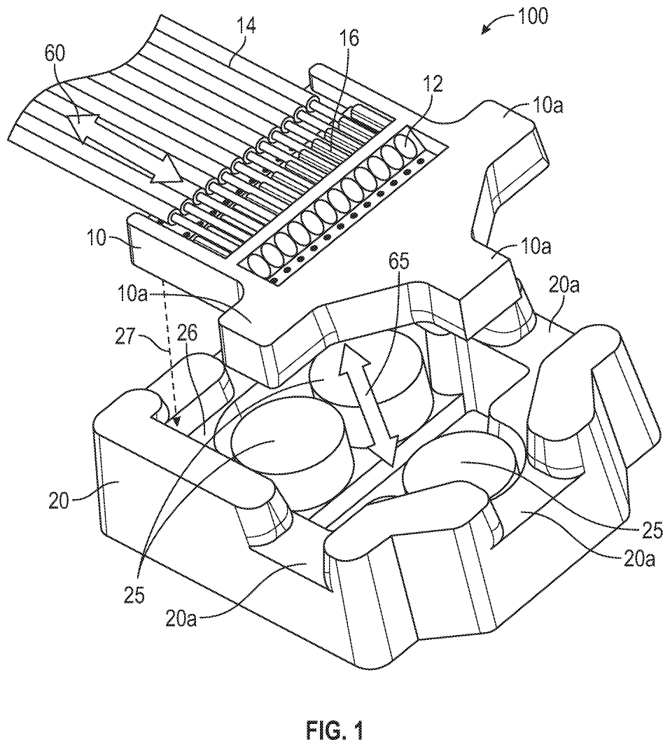

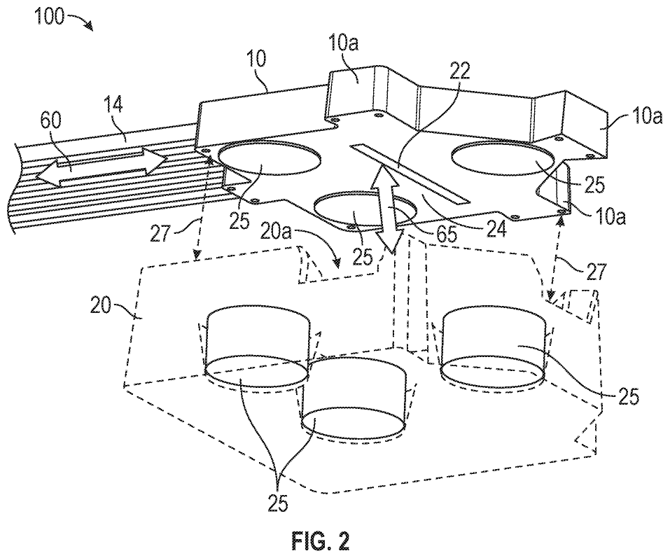

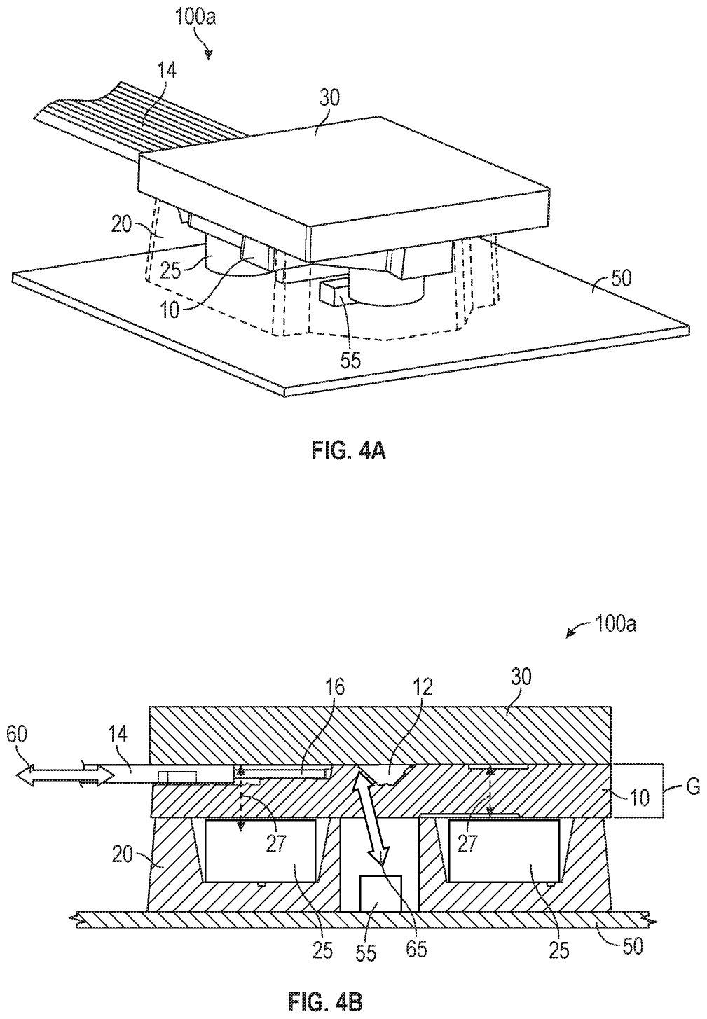

Turning to the figures, FIGS. 1 and 2 show exploded, perspective views of an optical assembly 100 in accordance with an embodiment described herein. An optical ferrule 10 including a light redirecting member 12 receives light from one or more optical waveguides 14 through an attachment area 16 along a first direction 60, and redirects the light along a different second direction 65. The received light passes through the light redirecting member 12 and exits the optical ferrule 10 at an exit location 22 on a mating surface 24 of the optical ferrule 10. A cradle 20 including a mating surface 26 is configured to hold and align the optical ferrule 10 to an optical component (not shown, see item 55, FIG. 4A). It should be noted that light may travel from the optical component back to the optical ferrule 10, as well as from the optical ferrule 10 to the optical component. That is, the path the light travels defined by arrows 60 and 65 may be bidirectional.

It should be noted that the term “mating surface” as used herein refers to a side or face of a component which must be adjacent to and/or aligned with a side or face of another component. In some embodiments, the mating surfaces of two components may not be in actual physical contact with each other. For example, in some embodiments, two mating components may have alignment members or alignment surfaces which make physical contact, allowing the “mating surfaces” of the two components to be held near to and adjacent to each other (e.g., to allow the alignment of optical features of each component with each other.)

In some embodiments, the mating surface 24 of the optical ferrule 10 and the mating surface 26 of the cradle 20 are held together by a magnetic attraction. In some embodiments, the magnetic attraction is applied between the mating surface 24 of the optical ferrule 10 and the mating surface 26 of the cradle 2 in a direction substantially orthogonal to the first direction 60 (e.g., in direction 27). In other words, when mated, the optical ferrule 10 is held in place in cradle 20 by the magnetic attraction in the direction 27, and de-mating of the optical ferrule 10 from the cradle 20 occurs in a direction substantially orthogonal to first direction 60. In some embodiments, to improve alignment between the optical ferrule 10 and the cradle 20 (and thus, the optical component 55), the optical ferrule 10 may include engagement features 10a which fit into corresponding alignment members 20a in cradle 20 when the optical ferrule 10 is properly seated within cradle 20. This pairing of engagement features 10a and alignment members 20a substantially limit movement in the plane parallel to the mating surface 24 of optical ferrule 10, while the magnetic attraction substantially limits movement in a plane orthogonal to mating surface 24.

In some embodiments, the magnetic attraction is provided by magnetic components 25 (also referred to as magnetic features 25) in the optical ferrule 10 and the cradle 20. These magnetic components 25 may include, but not be limited to, one or more of the following: permanent magnets, ferromagnetic materials, and electromagnets. In some embodiments, the optical ferrule 10 may incorporate or be attached to a permanent magnet (e.g., a nonmetallic body incorporating a permanent magnet), and the cradle 20 may be constructed from or contain a ferromagnetic material. In some embodiments, the cradle 20 may be stamped from a sheet of ferromagnetic material. In other embodiments, the cradle 20 may be made of a non-metallic material (e.g., a polymer) incorporating a ferromagnetic filler material.

It is important to note that, in some embodiments, the engagement features 10a on optical ferrule 10 being seated in corresponding alignment members 20a in cradle 20 provides for retention of the ferrule 10 within the cradle 20 in the plane parallel to mating surface 24, and magnetic components 25 provide an attractive force that acts in a direction outside of the plane parallel to mating surface 24. In some embodiments, the attractive force may act in a direction substantially orthogonal to the plane parallel to mating surface 24. That is, in some embodiments, the magnetic components 25 provide for retention and proper seating of the optical ferrule 10 down into cradle 20, and the engagement features 10a help align and retain the optical ferrule 10 in the cradle 20 in the plane parallel to the mating surfaces.

It is also important to note that, in some embodiments, a gap may exist between the magnetic components 25 in the optical ferrule 10 and the magnetic components 25 of the cradle 20 when the optical ferrule 10 is properly mated with the cradle 20. This gap is such that a constant magnetic force between magnetic components 25 in the optical ferrule 10 and magnetic components 25 in the cradle 20 is maintained, resulting in an attractive/retention force that keeps the optical ferrule 10 properly mated with cradle 20. The gap also allows for the placement of the magnetic components 25 within the optical ferrule 10 and cradle 20 without requiring precision placement or assembly.

In other embodiments, the optical ferrule 10 may incorporate or be attached to a ferromagnetic material, and the cradle 20 may incorporate or be attached to a permanent magnet. In some embodiments, the optical ferrule 10 may be stamped from a sheet of ferromagnetic material. In other embodiments, the optical ferrule 10 may be made of a non-metallic material (e.g., a polymer) incorporating one or more ferromagnetic inserts. In some embodiments, the ferrule may have a substantially transparent body bonded to or otherwise adhered to magnetic components 25. For example, one or more magnetic components 25 may be adhesively bonded to optical ferrule 10. As another example, one or more magnetic components 25 may be attached by insert molding into the body of the ferrule 10. As yet another example, one or more magnetic components 25 may be attached by press fitting the components into the body of the ferrule 10.

In still other embodiments, both the optical ferrule 10 and cradle 20 may incorporate or be attached to permanent magnets. The permanent magnets used in any of these embodiments may have a Curie temperature (i.e., a temperature above which a magnet ceases to exhibit spontaneous magnetization) higher than any temperature used in a process of bonding (e.g., soldering) the cradle 20 to the optical component, to prevent a loss of magnetic attraction during manufacturing.

For the purposes of this specification, a ferromagnetic material shall be defined to be any material having a high susceptibility to magnetization, the strength of which depends on that of the applied magnetic field, and for which magnetic properties may persist after removal of the applied magnetic field. Examples of ferromagnetic materials include, but are not limited to, iron, cobalt, nickel, alloys or compounds containing one or more of these elements, and some rare-earth elements. Permanent magnets shall be defined as any material which can be magnetized by an external magnetic field and which remains magnetized after the external field is removed. A permanent magnet may be made from a ferromagnetic material, but not all ferromagnetic materials are permanent magnets.

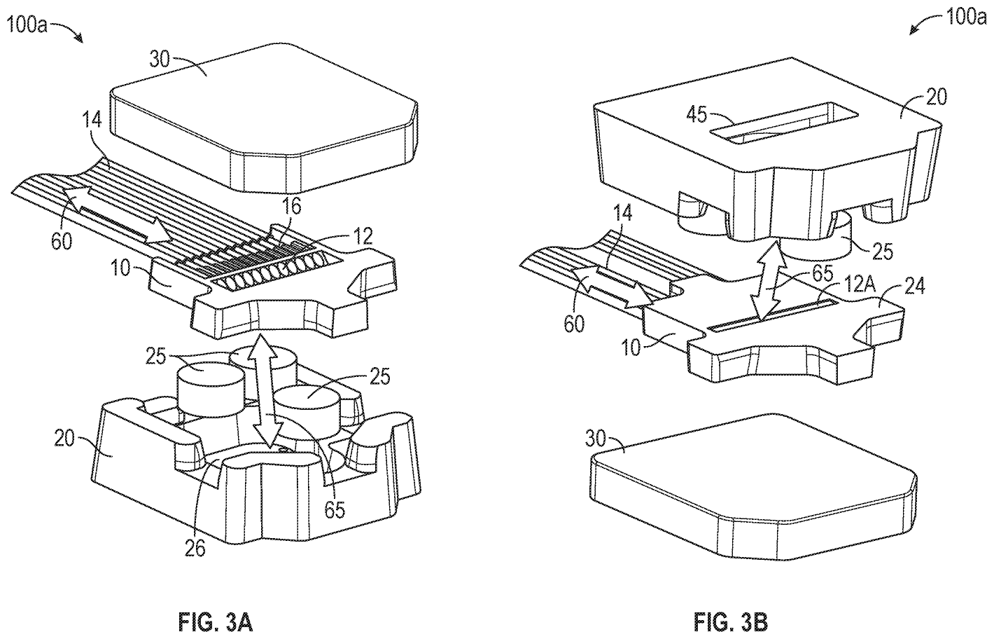

In some embodiments, it may be beneficial to create the magnetic attraction between the cradle 20 and a separate component, such as a cap, where the optical ferrule is trapped and held in place between the separate component and the cradle 20. FIGS. 3A and 3B provide exploded, perspective views of an example embodiment of an optical assembly 100a where the magnetic attraction occurs between magnetic components 25 in the cradle 20 and a cap 30. FIG. 3A shows the view from an angle showing the top (cap-side) of optical ferrule 10, and FIG. 3B shows the view from an angle showing the bottom (cradle-side) of optical ferrule 10.

The components of FIGS. 3A and 3B which are substantially similar to like components in previous figures shall have like reference designators. An optical ferrule 10 including a light redirecting member 12 receives light from one or more optical waveguides 14 (e.g., optical fibers). In some embodiments, the optical waveguides 14 are connected to the optical ferrule 10 through an attachment area 16 on the optical ferrule 10. Light is received by the optical ferrule 10 from the optical waveguides 14 in a first direction 60, and is redirected by the light redirecting member 12 along a second direction 65. The redirected light exits the optical ferrule on a first mating surface 24 of the optical ferrule 10 and enters a cradle 20 on a second mating surface 26 of the cradle 20. The second mating surface 26 may include a hole 45 through which the redirected light passes, where it can enter into an optical component (not shown, see optical component 55, FIG. 4A) to which the cradle 20 is mounted. In some embodiments (e.g., when the optical component is a light source), light may travel from the optical component back through light redirecting member 12 and into optical waveguides 14. That is, light may travel the path defined by arrows 60 and 65 in either direction.

In some embodiments, the optical assembly 100a may include a cap 30. In such embodiments, the optical ferrule 10 may be disposed between the cradle 20 and cap 30, and a magnetic attraction between the cradle 20 and cap 30 holds the optical ferrule 10 in place. In some embodiments, the cap 30 may be constructed of a ferromagnetic material, which is attracted to magnetic components 25 (e.g., permanent magnets) in the cradle 20. In some embodiments, the cap 30 may be constructed of a non-metallic material (e.g., a polymer) but incorporate magnetic components (e.g., permanent magnets or ferromagnetic materials). In some embodiments, cap 30 may be fashioned by stamping a flat ferromagnetic material, such as a sheet metal.

In the example embodiments shown in FIGS. 3A and 3B, magnetic components (e.g., magnets) 25 are shown as being disposed in the cradle 20, and cap 30 is made of a ferromagnetic material to which the magnetic components 25 are attracted. In some embodiments, when the magnetic components 25 in the cradle 20 are permanent magnets, the permanent magnets may exhibit a Curie temperature higher than any temperature used in a process (e.g., a soldering process) of bonding the cradle 20 to the optical component.

However, in some embodiments, it may be beneficial to construct cradle 20 of a ferromagnetic material and to place the magnetic components 25 in the cap 30. For example, as the process required to attach the cradle 20 to an underlying optical component (not shown) may require a high temperature, it may be advantageous to move the magnetic components 25 into the cap 30 to avoid requiring magnets with high Curie temperatures to be used in the cradle 20. That is, magnets placed in cap 30 may be able to have a lower Curie temperature than if they are placed in the cradle 20 (where the soldering or other attachment process is occurring), reducing the overall cost of the magnets needed. In such embodiments, the cap 30 could be constructed from a non-metallic material (e.g., a polymer) with integral permanent magnets. In some embodiments, both the cap 30 and cradle 20 may have permanent magnets.

It should be noted that, as with the magnetic attraction between the optical ferrule 10 and cradle 20 discussed elsewhere herein, various embodiments of the magnetic attraction between cap 30 and cradle 20 are possible without deviating from the intent of the disclosure. For example, in some embodiments, the magnetic attraction may be provided by magnetic components 25 in both the cap 30 and the cradle 20. These magnetic components 25 may include, but not be limited to, one or more of the following: permanent magnets, ferromagnetic materials, and electromagnets.

FIG. 4A is a perspective view of an assembled optical assembly 100a as mounted onto a substrate 50 with an optical component 55. In some embodiments, an optical ferrule 10 (only partially seen) is trapped between a cradle 20 and a cap 30. A magnetic attraction (i.e., a magnetic force) acts to hold the cap 30 in place on the cradle 20, resisting the movement of the optical ferrule 10 in a direction that would lift it up out of the cradle 20. In some embodiments, the magnetic attraction is provided by magnetic components 25 within the cradle 20, which are attracted to or attracted by magnetic components or ferromagnetic materials in cap 30. The optical assembly 100a provides for retention of the optical ferrule 10 in cradle 20, and provides alignment between the optical ferrule 10 and optical component 55, such that light propagates efficiently from optical waveguides 14, through optical ferrule 10 and cradle 20, into optical component 55.

It is important to note that optical assembly 100 as shown in FIGS. 1 and 2, as well as other variations of the optical assembly, may be mounted to a substrate 50 and aligned with an optical component 55 in a manner similar to that shown in FIG. 4A.

FIG. 4B is a cross-sectional side view of the assembled optical assembly of FIG. 4A. Light propagates through optical waveguides 14 in a first direction 60. The optical waveguides 14 are coupled to a light redirecting member 12 within optical ferrule 10 through attachment area 16. The light redirecting member 12 redirects the light in a different, second direction 65. In some embodiments, second direction 65 may be orthogonal to first direction 60. In other embodiments, second direction 65 may be at any appropriate angle relative to first direction 60, including, but not limited to, 8, 15, 30, 45, 75, 90, 100, 135, 150, or 175 degrees. The redirected light travels in second direction 65, passing through cradle 20 into optical component 55. Magnetic components 25 within the cradle 20 and cap 30 are magnetically attracted to each other, providing a force in a third direction 27 acting to hold optical ferrule 10 seated in cradle 20. In some embodiments, the magnetic components 25 in the cradle 20 and cap 30 are separated by a physical gap, G. In the embodiment of FIG. 4B, the gap, G, is created by the body of optical ferrule 10, which prevents the magnetic components 25 in the cradle 20 from coming in direct physical contact with the cap 30. In some embodiments, cap 30 may be omitted, and the magnetic attraction occurs between magnetic components 25 in both the optical ferrule 10 and cradle 20. In some embodiments, magnetic components 25 may be positioned in a recess in the ferrule 10, cradle 20, or both, such that an air gap remains between opposing magnetic components even when the ferrule 10 is properly seated within cradle 20.

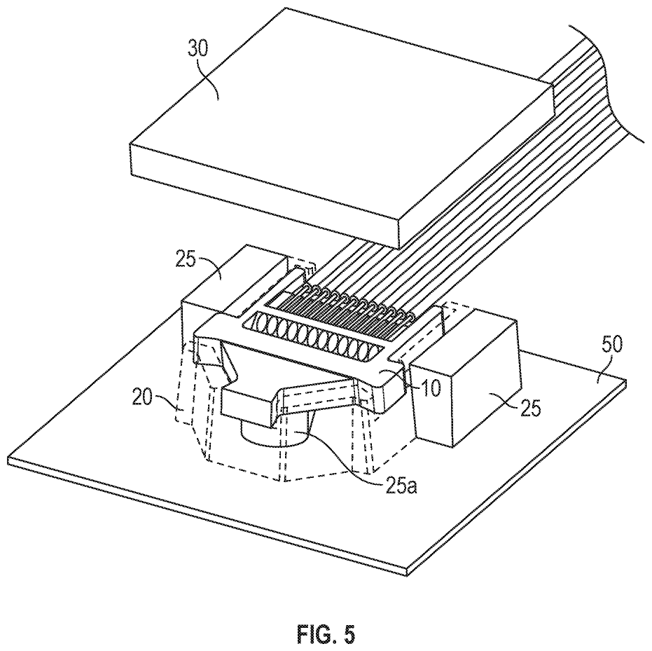

FIG. 5 is an exploded, perspective view of an alternate embodiment of an optical assembly of FIGS. 4A and 4B, where at least some of the magnetic components 25 are mounted on an exterior surface of cradle 20. In some embodiments, additional magnetic components 25a may be disposed inside cradle 20, while in other embodiments, only the exterior magnetic components 25 are present. A cap 30, constructed of a magnetic or ferromagnetic material, is attracted to magnetic components 25 (and/or 25a) such that the optical ferrule 10 is held in place and aligned with the optical cradle 20 (and therefore also aligned with optical component 55 as necessary).

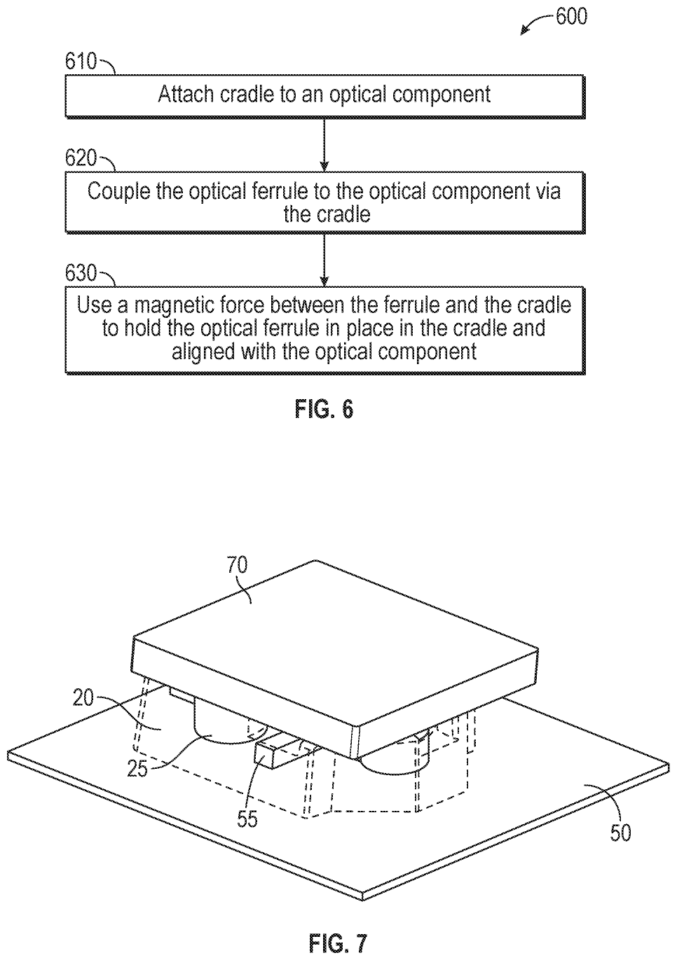

FIG. 6 is a flowchart detailing a method 600 for coupling an optical ferrule to an optical component in accordance with an embodiment described herein. In step 610, a cradle is attached to an optical component, such as a light source or a light detector mounted on a substrate. The attachment may be achieved by any appropriate process, but may include soldering, adhesives, and or mechanical features. In some embodiments, step 610 may further include using an end effector (e.g., a robotic gripper on a robotic arm) equipped with an electromagnet to pick up the cradle, place the cradle on the substrate, to perform the attachment step, and/or to release the cradle. In step 620, the optical ferrule is coupled to the optical component via the cradle. That is, the optical ferrule shall be seated in the cradle such that a mating surface of the optical ferrule is held adjacent to and facing a mating surface of the cradle, such that the optical ferrule and optical component are optically aligned. In step 630, a magnetic force between the optical ferrule and the cradle is used to hold the optical ferrule in place seated in the cradle and aligned properly with the optical component.

In some embodiments, the optical ferrule includes a light redirecting member which receives light from an optical waveguide along a first direction and redirects the light along a different second direction, such that the redirected light exits the light redirecting member at an exit location on the mating surface of the optical ferrule. In some embodiments, the magnetic force applied in step 630 is applied between the mating surface of the optical ferrule and the mating surface of the cradle in a second direction different than the first direction. In some embodiments, the second direction is substantially orthogonal to the first direction.

In some embodiments, magnetic components within the optical ferrule and the cradle provide the magnetic force (i.e., magnetic attraction). These magnetic components may include, but are not limited to, permanent magnets, ferromagnetic materials (including the materials from which the ferrule and/or cradle are constructed), and electromagnets. In some embodiments, when permanent magnets are used within the cradle, the permanent magnets may have a Curie temperature which is higher than any temperature used in attaching the cradle to the substrate.

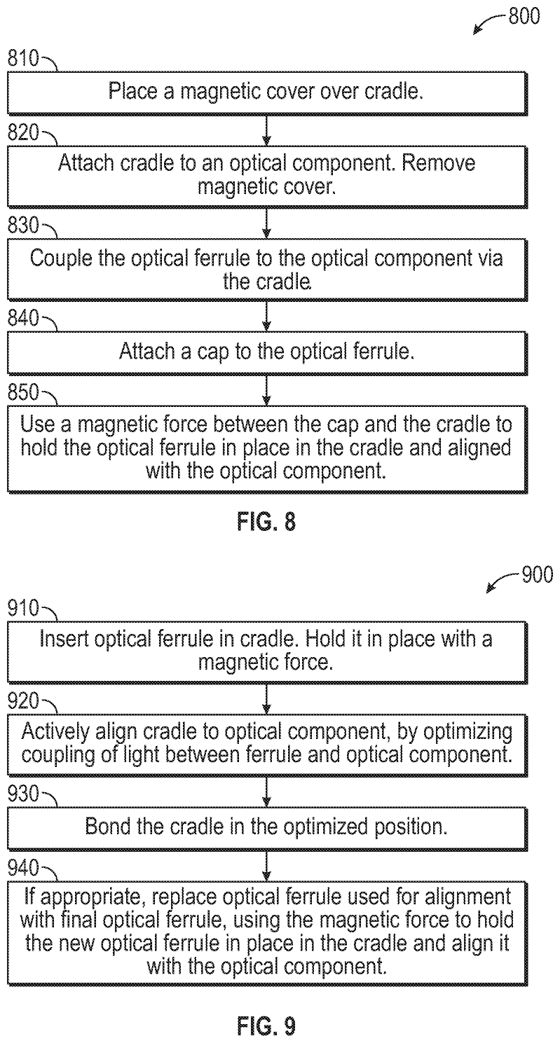

In some embodiments of the method, the cradle may be first covered with a temporary cover to protect the cradle during the attachment process, or subsequent handling processes. An example embodiment of such a cover is shown in FIG. 7. FIG. 7 is a perspective view of a cover 70 used for assembling a cradle 20 to an optical component 55 on a substrate 50. In some embodiments, the cover 70 may be a magnetic cover, which exhibits a magnetic attraction with the cradle 20. This magnetic attraction may be formed by magnetic components 25 in the cradle 20 and/or the cover 70. In some embodiments, the cradle 20 may include permanent magnets, and the cap 70 may be made of a ferromagnetic material. In other embodiments, the cap 70 may include permanent magnets, and the cradle 20 may be made of a ferromagnetic material. In still other embodiments, both the cap 70 and cradle 20 may include permanent magnets, oriented such that the cap 70 and cradle 20 are attracted to each other. In some embodiments, once the cradle 20 has been attached to the substrate 50 and aligned with optical component 55, the cover 70 may be removed, or may be left on for subsequent processing or transport, until the ferrule is placed in the cradle 20. In some embodiments, the cover 70 may be reused in other cradle attachment procedures. In some embodiments, the cover 70 may be composed of magnetized ferromagnetic alloy with a high Curie temperature, such as a samarium-cobalt alloy, or any appropriate material with a sufficiently high Curie temperature such that cover 70 does not lose any of its magnetic abilities when exposed to the potentially high processing temperatures (e.g., the temperature of soldering the cradle 20 to the substrate 50.

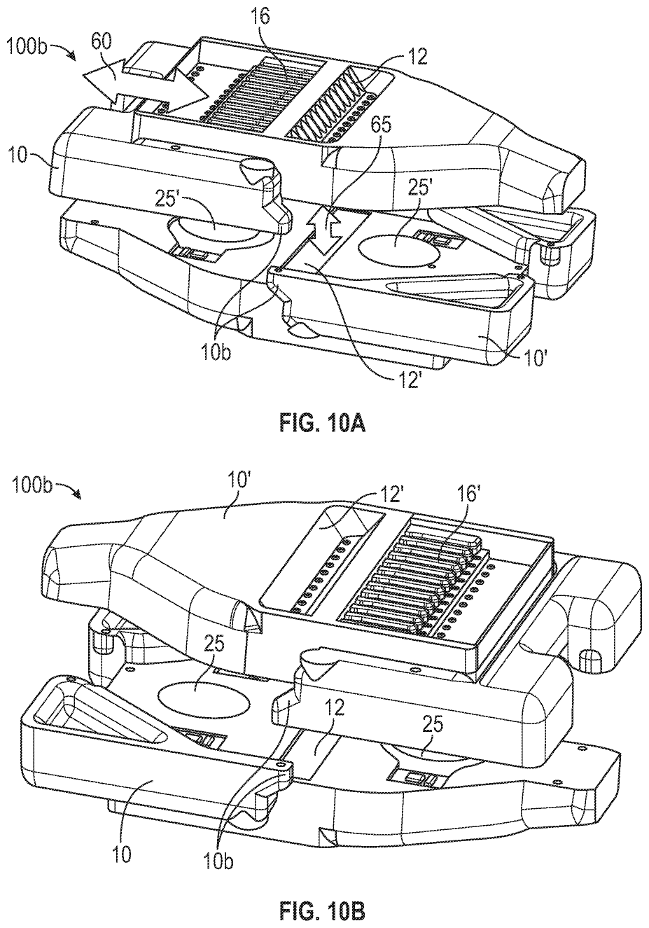

FIG. 8 is a flowchart detailing a method of coupling an optical ferrule to an optical component, using the magnetic cover of FIG. 7. In step 810, a magnetic cover is placed over the cradle. As discussed elsewhere herein, the magnetic cover is attracted to the cradle through a magnetic attraction created between magnetic components within both the cover and the cradle. In step 820, the cradle with magnetic cover in place is attached to the substrate and aligned with the optical component. Following attachment, the magnetic cover may be removed and either discarded or reused in another attachment operation, or it may be left in place to protect the cradle until the ferrule is mated to it. In step 830, the optical ferrule is coupled to and aligned with the optical component via the cradle.

In step 840, a cap is attached to the optical ferrule. The cap has a magnetic attraction with the cradle, and through this magnetic attraction, the optical ferrule is held in place, sandwiched between the cap and the cradle. It should be noted that, in some embodiments, the cap may be adhered or otherwise bonded to the optical ferrule. This adhering may be completed prior to step 830 (i.e., the order of steps 830 and 840 may be swapped). In some embodiments, the cap is not adhered to the optical ferrule, but is instead held in place by the magnetic attraction between the cap and the cradle. In step 850, the magnetic force (i.e., magnetic attraction) between the cap and cradle is used to hold the optical ferrule in place, seated in the cradle and aligned with the optical component.

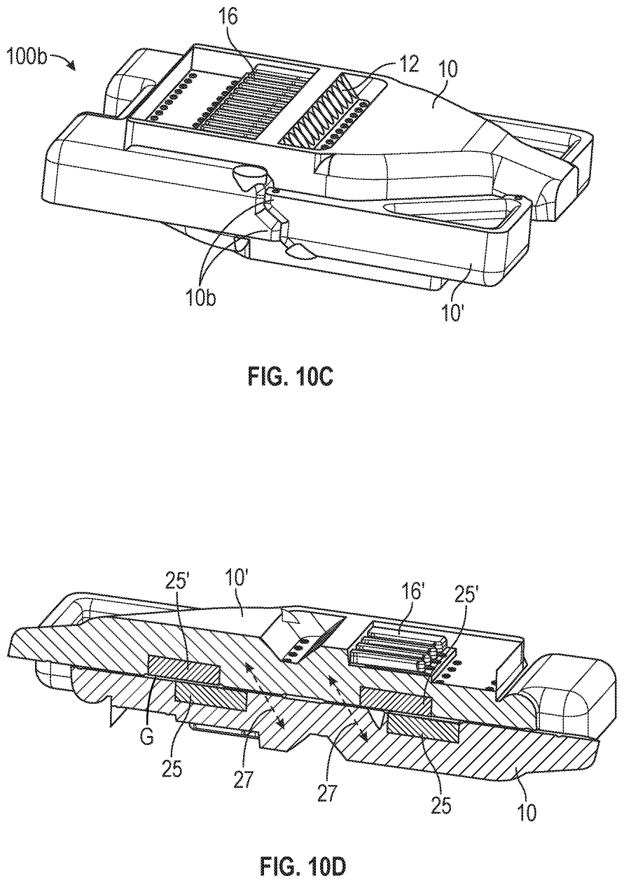

FIG. 9 is a flowchart detailing a method for using an optical ferrule to align a cradle to an optical component in accordance with an embodiment described herein. In step 910, an optical ferrule is seated into the cradle, and held in place with a magnetic force (i.e., a magnetic attraction between the optical ferrule and cradle). In some embodiments, the optical ferrule used may be the optical ferrule intended to be coupled with the optical component. In other embodiments, the optical ferrule used may be a second, different optical ferrule, such as an optical ferrule affixed to a robotic test or assembly fixture, used temporarily to align the cradle to the optical component, and later removed. In step 920, the cradle is actively aligned to the optical component by directing light into the optical ferrule and moving the cradle until the coupling of light between the optical ferrule and the optical component is optimized. In step 930, the cradle is bonded to the optical component in the optimal position. In step 940, if the optical ferrule used in the alignment was a temporary ferrule used for alignment, this optical ferrule may be replaced with a temporary plug (i.e., that is, a plug of material that is shaped to fill the cradle as a ferrule would and which is magnetic or ferromagnetic) held in place by magnetic force, or with the new, final optical ferrule and held in place and aligned with the cradle using the magnetic force (i.e., magnetic attraction).

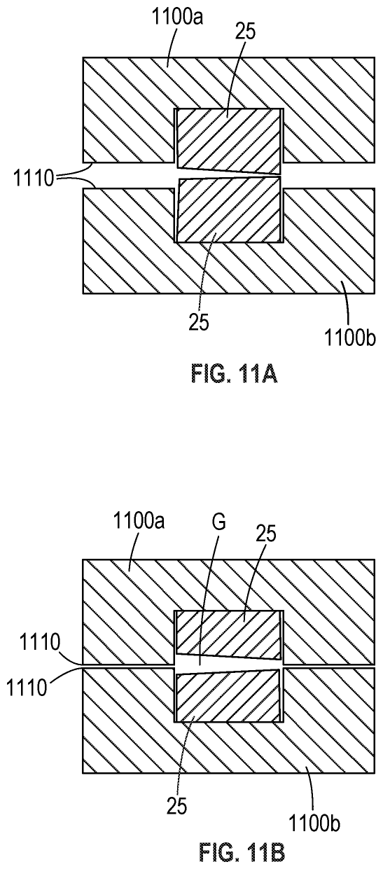

FIGS. 10A-10D present perspective views of alternate embodiments of an optical assembly where the receiving component of the (first) optical ferrule is a second optical ferrule, instead of a cradle. In this embodiment, a first optical ferrule 10 includes an attachment area 16 where optical waveguides (element 14 of FIG. 1, omitted here for clarity) are coupled to a light redirecting member 12. As with previous examples, light received from optical waveguides 14 (FIG. 1) enters light redirecting member 12 along a first direction 60, and is redirected along a second, different direction 65. Light exiting the light redirecting member 12 of optical ferrule 10 then enters the light redirecting member 12′ of a second optical ferrule 10′, where it is redirected through the attachment area 16′ on the second optical ferrule 10′, entering the optical waveguides (not shown) attached to attachment area 16′. It should be noted that light can travel in both directions between first optical ferrule 10 and second optical ferrule 10′.

The first optical ferrule 10 and second optical ferrule 10′ may be held in place and aligned with each other through the use of magnetic components 25 and 25′. The first optical ferrule 10 and second optical ferrule 10′ may have complimentary mechanical engagement features 10b which interface and/or interlock to help maintain the contact and alignment between the optical ferrules 10 and 10′.

FIG. 10D is a cutaway side view of the first optical ferrule 10 attached to the second optical ferrule 10′. In some embodiments, the magnetic components 25 of the first optical ferrule 10 may be offset from the magnetic components 25′ of the second optical ferrule 10′ when the two ferrules are properly mated. By offsetting magnetic components 25 and 25′ as shown in the example embodiment of FIG. 10D, the natural tendency of the two sets of magnetic components 25/25′ to align over top of each other produces a retention/attraction force in both the axial and vertical directions, resulting in magnetic attraction acting in a resultant vector 27. In other words, offsetting the magnetic components 25/25′ not only holds the first optical ferrule 10 in contact with the second optical ferrule 10′, but also helps pull mechanical engagement features 10b (see FIGS. 10A-10C) of both ferrules 10/10′ fully engaged. In some embodiments, a gap, G, remains between the magnetic components 25 of the first optical ferrule 10 and the magnetic components 25′ of the second optical ferrule 10′, to maintain a retention/attraction force between ferrules without requiring precise placement of the magnetic components within the ferrules.

It should be noted that the magnetic attraction between optical ferrules 10/10′ as shown in FIGS. 10A-10B may be alternately provided by separate components bonded externally to the ferrules. For example, the cap 30 shown in FIGS. 3A-5 may be adhered to the non-mating side of each ferrule, and the magnetic attraction that holds the first optical ferrule 10 to the second optical ferrule 10′ may come from an attraction between the caps 30 mounted to each ferrule 10/10′. As with the internal magnetic components 25/25′ shown in FIG. 10D, caps 30 could be similar offset to create the axial and vertical forces of attraction.

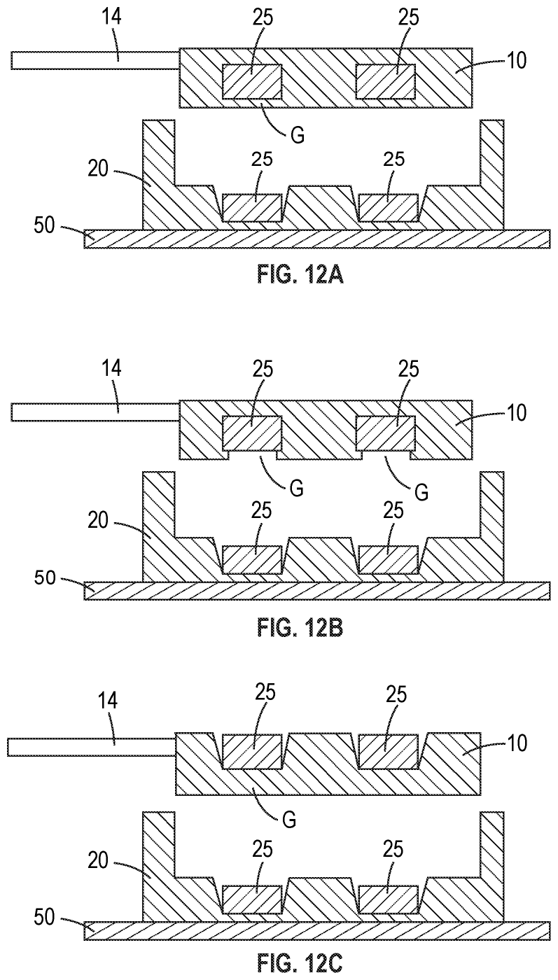

FIGS. 11A and 11B illustrate a method of maintaining a gap between magnetic components to provide a residual magnetic force between mating surfaces in an optical assembly. As previously described herein, in some embodiments, a gap is maintained between magnetic components in order to provide the attractive force necessary to hold system components in a proper mated position, but without requiring precise magnetic components or precision placement of the magnetic components during assembly. FIG. 11A illustrates an embodiment without a gap between magnetic components 25 in opposing mating components 1100a and 1100b. It should be noted that components 1100a and 1100b could be any two mating components in an optical assembly in accordance with embodiments described herein, such as, for example, an optical ferrule and a cradle, or opposing optical cradles. Each of opposing mating components 1100a and 1100b have precision surfaces 1110 which may be required to be in contact with each other and properly aligned (i.e., precision surfaces 1110 held in precise contact and alignment) in order for the optical assembly to perform as designed. However, as illustrated in FIG. 11A, the magnetic components 25 may not themselves have precision mating surfaces, or may be seated in the corresponding mating component 1100a/1100b at a slight angle during manufacture, preventing mating components 1100a and 1100b from being in contact, or at least from being in precise alignment.

In FIG. 11B, magnetic components 25 are mounted inside corresponding mating components 1100a/1100b such that there is a gap, G, maintained between the magnetic components 25. In this embodiment, even though magnetic components 25 may have irregular surfaces, or may be mounted at a slight angle, the gap, G, allows precision mating surfaces 1110 from mating component 1100a and mating component 1100b be in contact and proper alignment. The gap, G, between magnetic components 25 allows a residual magnetic force (i.e., magnetic attraction) to be maintained, holding the mating components 1100a/1100b together such that all precision surfaces 1110 are properly in contact.

One advantage of maintaining gap, G, between the magnetic components 25 is that the tolerances in the features of the magnetic components 25 will not affect the attachment. If the manufacture of the magnetic components 25 allows for variations from component to component (i.e., parts tolerances), the variability may be absorbed by the gap, G, rather than affecting the placement of the magnetic components 25 relative to one another. Even if the magnetic components 25 vary in size, a residual attractive force between the magnets will keep them together. If the magnets are allowed to touch, there is no residual force and changes in size may result in misalignment.

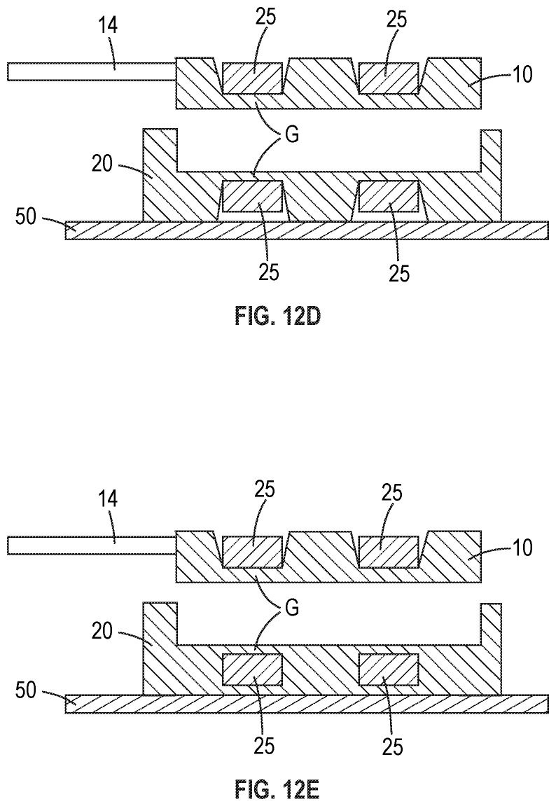

FIGS. 12A-12E provide cross-sectional, exploded views of an optical assembly in accordance with embodiments of the present description. In these figures, the optical assembly is shown as an optical ferrule 10 interfacing with a cradle 20. However, FIGS. 12A-12E are intended to be illustrative only, and are not limiting. The optical assembly could also be between a first optical ferrule and a second optical ferrule, between an optical ferrule and an optical component (e.g., a light source or a light detector), between a magnetic “cap” and a cradle (e.g., a cap of ferromagnetic material and a cradle with magnetic components, sandwiching an optical ferrule in between them), or between any two or more appropriate components in an optical assembly. FIGS. 12A-12E are largely identical, using common reference designators for common components, and the following description will apply to each of the drawings equally unless otherwise noted. The intent of FIGS. 12A-12E is to illustrate various positions and placements of magnetic components in one or more optical components in an optical assembly.

FIGS. 12A-12B show an optical ferrule assembly configured to be assembled to a receiving component 20 (e.g., a cradle) by a magnetic attraction. In some embodiments, the optical ferrule assembly includes an optical ferrule, and a magnetic feature 25 (e.g., magnets) embedded in the optical ferrule 10, and configured to engage the optical ferrule 10 to the receiving component 20 by a magnetic attraction (e.g., between magnetic features 25 in optical ferrule 10 and magnetic features 25 in receiving component 20.) In the embodiments depicted in FIG. 12A, the magnetic features 25 are fully embedded within optical ferrule 10. In other embodiments, such as the embodiment shown in FIG. 12B, the magnetic features 25 are partially embedded within the optical ferrule 10 (i.e., at least a portion of magnetic features 25 may be exposed). In some embodiments, the optical ferrule 10 may include an optical waveguide support configured to receive an optical waveguide 14, and a light redirecting member configured to receive light from an optical waveguide 14 received in the optical waveguide support along a first direction and redirect the received light along a different second direction (not shown in FIGS. 12A-12B, but discussed elsewhere herein). In both embodiments of FIGS. 12A-12B, magnetic features 25 are kept separated from the magnetic features 25 of the receiving component 20 by a gap G, due to their nature of being fully or partially embedded within optical ferrule 10. As discussed elsewhere herein, the gap G keeps the magnetic features 25 of the optical ferrule 10 and receiving component 20 from coming in direct contact, leaving a residual magnetic attraction between mating surfaces without requiring precision placement or manufacture of the magnetic features. In some embodiments, the magnetic features 25 are also recessed into the receiving component 20, such that the top surface of magnetic features 25 (i.e., the surface of the features facing up toward optical ferrule 10 in FIGS. 12A-12C) does not rise above the top surface of the receiving component 20 (i.e., allowing the mating surface of receiving component 20 and the corresponding mating surface of the optical ferrule 10 to contact directly without interference from a portion of the magnetic features 25).

Similarly, FIG. 12C provides a gap G between the magnetic features 25 of optical ferrule 10 and receiving component 20, but in this embodiment, the gap G is provided by disposing the magnetic features 25 on a side of optical ferrule 10 opposite the surface of optical ferrule 10 from which the redirected light exits the optical ferrule 10. That is, received light enters optical ferrule 10 via optical waveguide 14, is incident on a light redirecting member and is redirected out of an exit surface of optical ferrule 10 into the receiving component 20. In some embodiments, magnetic features 25 may be placed on a side of optical ferrule 10 opposite this exit surface (i.e., opposite the side adjacent the receiving component 20.) It should be noted that, although FIG. 12C depicts magnetic features 25 disposed in recesses in the top surface of optical ferrule 10 (i.e., the surface shown in FIG. 12C on a top side of ferrule 10), in other embodiments, the top surface of optical ferrule 10 may be substantially planar (or any appropriate surface shape), and the magnetic features 25 may not be recessed into the optical ferrule 10 as shown in FIG. 12C.

The embodiment of FIG. 12D illustrates how the magnetic features 25 of the receiving component 20 may be disposed on a side of the receiving component 20 opposite the side of the receiving component 20 facing the optical ferrule 10. That is, magnetic features 25 may be disposed on a bottom surface of the receiving component 20, where “bottom” is the side of receiving component 20 that is adjacent substrate 50. In some embodiments, the magnetic features 25 may sit in recesses, as shown in FIG. 12D, or the bottom side of receiving component 20 may be substantially planar and the magnetic features may be disposed on the substantially planar surface.

In some embodiments, such as that of FIG. 12E, the magnetic features 25 may be fully embedded within the body of receiving component 20, similar to the magnetic features 25 embedded in the optical ferrule 10 in FIG. 12A. In some embodiments, the magnetic features 25 may also be partially embedded within the receiving component 20.

FIGS. 12A-12E are illustrative and not limiting in any way. Various embodiments may be created using any combination of the concepts illustrated in FIGS. 12A-12E, as well as concepts described in the other figures herein, without deviating from the intent of the present description.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical assembly, comprising:
an optical ferrule comprising a light redirecting member configured to receive light from an optical waveguide along a first direction and redirect the light along a different second direction, the redirected light exiting the optical ferrule at an exit location on a mating surface of the optical ferrule; and
a cradle comprising a mating surface and configured to hold and align the optical ferrule to an optical component;
wherein the mating surface of the optical ferrule and the mating surface of the cradle are held together by a magnetic attraction between opposing magnetic elements, wherein the optical ferrule and the cradle, but not the opposing elements, physically contact each other.

2. The optical assembly of claim 1, wherein the magnetic attraction is applied between the mating surface of the optical ferrule and the mating surface of the cradle in a direction substantially orthogonal to the first direction.

3. The optical assembly of claim 1, wherein a de-mating of the optical ferrule from the cradle occurs in a direction substantially orthogonal to the first direction.

4. (canceled)

5. (canceled)

6. The optical assembly of claim 1, wherein the opposing magnetic elements comprise a permanent magnet in the optical ferrule and a ferromagnetic material in the cradle.

7. The optical assembly of claim 6, wherein the cradle further comprises a stamped ferromagnetic material.

8. The optical assembly of claim 6, wherein the optical ferrule further comprises a nonmetallic body, and a permanent magnet.

9. The optical assembly of claim 6, wherein the cradle comprises a non-metallic material containing a ferromagnetic insert.

10. The optical assembly of claim 1, wherein the opposing magnetic elements comprise a ferromagnetic material in the optical ferrule and a permanent magnet in the cradle.

11. The optical assembly of claim 10, wherein the optical ferrule further comprises a stamped ferromagnetic material.

12. The optical assembly of claim 10, wherein the cradle further comprises a nonmetallic body, and a permanent magnet.

13. The optical assembly of claim 1, wherein the opposing magnetic elements comprise a permanent magnet in the optical ferrule and a permanent magnet in the cradle.

14. The optical assembly of claim 1, wherein at least one of the opposing magnetic elements comprises a permanent magnet, wherein the permanent magnet has a Curie temperature higher than any temperature used in a process of bonding the cradle to a substrate comprising the optical component.

15. The optical assembly of claim 1, further comprising a cap, wherein the ferrule is disposed between the cradle and the cap, and the opposing magnetic elements comprise a magnetic component in the cradle and a magnetic component in the cap.

16. The optical assembly of claim 15, wherein the cap comprises a permanent magnet and the cradle comprises a ferromagnetic material.

17. The optical assembly of claim 15, wherein the cap comprises a ferromagnetic material and the cradle comprises a permanent magnet.

18. The optical assembly of claim 15, wherein both the cap and the cradle further comprise permanent magnets.

19. The optical assembly of claim 15, wherein at least one of the cap and the cradle comprises a permanent magnet, wherein the permanent magnet has a Curie temperature higher than any temperature used in a process of bonding the cradle to a substrate comprising the optical component.

20.-38. (canceled)

39. An optical assembly, comprising:
an optical ferrule comprising a first mating surface and a first magnetic feature; and
a receiving component comprising a second mating surface and a second magnetic feature;
wherein the first mating surface of the optical ferrule is reversibly assembled to the second mating surface of the receiving component by a magnetic attraction between the first magnetic feature and the second magnetic feature, and the first magnetic feature and second magnetic feature are not in physical contact.

40. The optical assembly of claim 39, wherein the receiving component is a cradle aligned to an optical component.

41. The optical assembly of claim 39 wherein the receiving component is a second optical ferrule.

42.-61. (canceled)
